(19) United States
(12) Patent Application Publication
(10) Pub. No.: US 2026/0244937 A1
(43) Pub. Date: Aug. 20, 2026

(54) INFORMATION PROCESSING DEVICE, INFORMATION PROCESSING SYSTEM, AND INFORMATION PROCESSING METHOD

(71) Applicant: KABUSHIKI KAISHA TOSHIBA, Kawasaki-shi (JP)

(72) Inventor: Daisuke KOBAYASHI, Kokubunji (JP)

(73) Assignee: KABUSHIKI KAISHA TOSHIBA, Kawasaki-shi (JP)

(21) Appl. No.: 19/455,987

(22) Filed: Jan. 22, 2026

(30) Foreign Application Priority Data
Feb. 14, 2025 (JP) 2025-021984

(51) Int. Cl. G06N 3/09; G06N 3/0895; G06V 10/774

(52) U.S. Cl. CPC G06N 3/09; G06N 3/0895; G06V 10/774

(57) ABSTRACT

An information processing device 10 includes a generator 10B and a learning unit 10C. The learning unit 10C inputs each of the first category, into which the data 24 is classified, and the second category, into which the data 24 is classified more specifically than in the first category, to the generation model (the generation model 20) and generates the first data 24A belonging to the first category and the second data 24B belonging to the second category as output from the generation model. The learning unit 10C learns the recognition model 26 that outputs a recognition result from the data 24 by using the data 24 including the first data 24A and the second data 24B.

### CROSS-REFERENCE TO RELATED APPLICATIONS

This application is based upon and claims the benefit of priority from Japanese Patent Application No. 2025-021984, filed on February 14, 2025; the entire contents of which are incorporated herein by reference.

### FIELD

Embodiments described herein relate generally to an information processing device, an information processing system, and an information processing method.

### BACKGROUND

A method for learning a recognition model by using image data is disclosed. For example, a method of performing unsupervised learning of a recognition model by using pseudo samples generated using a pre-learned generation model is disclosed. There is also disclosed a method of performing supervised learning of a recognition model by using images generated by inputting a text of a category name into a generation model.

However, in the related art, since the recognition models are learned using only data that can be used for supervised learning or only data that can be used for unsupervised learning, either one of fidelity or diversity is missing in the learning. For this reason, in the related art, there is a case where the recognition accuracy of a recognition model cannot be improved.

### BRIEF DESCRIPTION OF THE DRAWINGS

FIG. 1 is a block diagram illustrating the configuration of an information processing system;

FIG. 2A is a schematic diagram of data;

FIG. 2B is a schematic diagram of data;

FIG. 3 is a flowchart illustrating a flow of information processing executed by an information processing device;

FIG. 4 is a block diagram illustrating a configuration of an information processing system;

FIG. 5 is a schematic diagram of a display screen;

FIG. 6 is a flowchart illustrating a flow of information processing executed by the information processing device; and

FIG. 7 is a hardware configuration diagram.

### DETAILED DESCRIPTION

According to an embodiment, an information processing device includes one or more hardware processors configured to function as a generator and a learning unit. The generator inputs each of a first category into which data is classified and a second category into which the data is classified more specifically than in the first category to a generation model and generates first data belonging to the first category and second data belonging to the second category as output from the generation model. The learning unit learns a recognition model that outputs a recognition result from the data by using the data including the first data and the second data. The learning unit herein may function also as a training unit configured to perform training (for example, train the recognition model).

Hereinafter, an information processing device, an information processing system, and an information processing method according to the present embodiments will be described in detail with reference to the accompanying drawings. The present disclosure is not limited to the following embodiments.

### First Embodiment

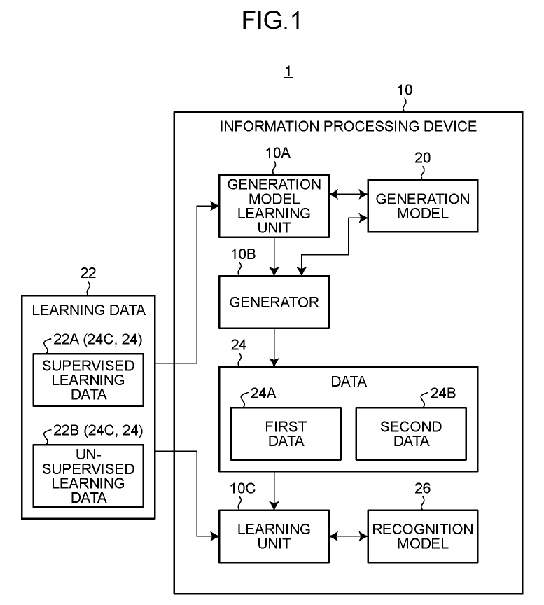

FIG. 1 is a block diagram illustrating an example of the configuration of an information processing system 1 of the present embodiment.

The information processing system 1 is a system for learning a recognition model 26. Details of the recognition model 26 will be described later. The information processing system 1 includes an information processing device 10. The information processing device 10 is an information processing device for learning the recognition model 26. In the present embodiment, the information processing device 10 learns a generation model 20 and the recognition model 26. Details of the generation model 20 and the recognition model 26 will be described later.

The information processing device 10 includes a generation model learning unit 10A, a generator lOB, and a learning unit 10C.

The generation model learning unit 10A, the generator lOB, and the learning unit 10C are implemented by, for example, one or a plurality of processors. For example, each of the above units may be implemented by causing a processor such as a central processing unit (CPU) or a graphics processing unit (GPU) to execute a program, namely, software. Each of the above units may be implemented by a processor such as a dedicated IC, namely, hardware. Each of the above units may be implemented by using software and hardware in combination. In the case of using a plurality of processors, each of the processors may implement one of the units, or may implement two or more of the units.

The generation model 20 and the recognition model 26, which will be described in detail later, may be stored in a storage unit provided in the information processing device 10. Furthermore, at least one of the generation model 20 or the recognition model 26 may be stored in a storage unit provided outside the information processing device 10. Furthermore, the storage unit and at least one of a plurality of functional units included in the information processing device 10 may be mounted on an external information processing device communicably connected to the information processing device 10 via a network or the like.

The generation model learning unit 10A learns the generation model 20 by using learning data 22.

The learning data 22 includes at least one of supervised learning data 22A or unsupervised learning data 22B.

The supervised learning data 22A includes a pair of third data 24C and a third category to which the third data 24C belongs. That is, the supervised learning data 22A is data in which the third category to which the third data 24C belongs is added to the third data 24C.

The third data 24C is an example of data 24.

The data 24 is data to be recognized by the recognition model 26. The data 24 is, for example, image data, but is not limited to image data. In the present embodiment, an aspect in which the data 24 is image data will be described as an example.

The third category is an exemplary category.

The category is data directly or indirectly representing correct data to be output from the recognition model 26 when the data 24 is input to the recognition model 26. In the present embodiment, the category is information indicating a label or a class of each group obtained by classifying a plurality of pieces of the data 24 into a plurality of groups in accordance with a predetermined classification rule. For example, it is assumed that the data 24 is image data in which a car is captured. In this case, the category is, for example, "car", "car type", "color of the car", or the like, but is not limited thereto.

In the supervised learning data 22A, information indicating a category to which the third data 24C belongs is given in advance as the third category to the third data 24C included in the supervised learning data 22A.

The unsupervised learning data 22B includes the third data 24C. That is, the unsupervised learning data 22B does not include the third category corresponding to the third data 24C.

The generation model 20 is a machine learning model having a category as input and the data 24 belonging to the input category as output. For the generation model 20, an image generation model is used that is capable of adding a condition with arbitrary text and outputting the data 24, such as a diffusion model (Stable Diffusion) (R. Rombach, et al., "High-Resolution Image Synthesis with Latent Diffusion Models", Proceedings of the IEEE/CVF conference on computer vision and pattern recognition. 2022) and an antagonistic generation model (Generative Adversarial Networks (GAN)) (Ian Goodfellow, et al. "Generative adversarial nets.", Advances in neural information processing systems 27, 2014).

The generation model learning unit 10A uses a first category and a second category as categories and learns the generation model 20 by using the plurality of pieces of learning data 22.

The first category is an exemplary category. The first category is a category in which the data 24 is classified more roughly than in the second category.

The second category is an exemplary category. The second category is a category in which the data 24 is classified more specifically than in the first category.

Accordingly, when the plurality of pieces of data 24 are classified, the number of pieces of the data 24 belonging to the first category is greater than or equal to the number of pieces of the data 24 belonging to one or a plurality of second categories. In addition, the first category includes the data 24 belonging to a plurality of different second categories, and various types of the diverse data 24 belong to the first category. On the other hand, the second category is a category in which the data 24 is classified more specifically than in the first category. As such, one or a plurality of pieces of the data 24 having high fidelity with respect to the second category belongs to the second category.

The generation model learning unit 10A learns the generation model 20 such that input of the first category results in output of the data 24 belonging to the first category. The generation model learning unit 10A also learns the generation model 20 such that input of the second category results in output of the data 24 belonging to the second category.

The generation model learning unit 10A specifies, as the first category, a category to which all of the plurality of pieces of third data 24C included in the plurality of pieces of learning data 22 belong.

For example, a case is presumed where the learning data 22 includes the supervised learning data 22A. In this case, the generation model learning unit 10A specifies, as the first category, a higher-level category collectively referring to a plurality of third categories included in a plurality of pieces of the supervised learning data 22A.

For example, a case is presumed where all of the plurality of pieces of third data 24C are the data 24 in which a car is captured. A case is further presumed where the third category included in the supervised learning data 22A is information indicating the model of cars. In this case, the generation model learning unit 10A specifies, for example, "car" as the first category as the higher-level category that collectively refers to a plurality of models of cars.

Then, the generation model learning unit 10A inputs text including the first category to the generation model 20 and learns the generation model 20 by a known method by using the plurality of pieces of learning data 22 so that first data 24A belonging to the first category is generated and output by the generation model 20.

The text input to the generation model 20 is, for example, "a photo of a (category)." or the like. Alternatively, the text input to the generation model 20 may be a method of adding any character string that is not generally used as an identifier "a sks (category)." or "a (v) (category)." in which a learnable prompt (v) is added, or the like.

The first data 24A is an example of the data 24. The first data 24A is the data 24 belonging to the first category. In a case where the first category is "car", the generation model learning unit 10A learns the generation model 20 such that input of the first category results in output of a plurality of pieces of various types of the diverse first data 24A in which a "car" is captured.

The generation model learning unit 10A uses each of the plurality of third categories included in the plurality of pieces of supervised learning data 22A as the second category. In a case where no supervised learning data 22A is included in the learning data 22, the generation model learning unit 10A is only required to specify, as the second category, a subordinate concept under the first category, namely, a category obtained by classifying the plurality of pieces of data 24 more specifically. In this case, the generation model learning unit 10A may specify a category stored in advance as the second category. The user may input in advance a desired category that can be used for the recognition result output from the recognition model 26 as the second category, and the information processing device 10 may store in advance the second category that has received the input in the storage unit.

For example, a case is presumed where all of the plurality of pieces of third data 24C are data 24 in which a car is captured. It is also presumed that the generation model learning unit 10A specifies "car" as the first category. A case is further presumed where the third category included in the supervised learning data 22A is information indicating the model of a car. In this case, the generation model learning unit 10A specifies each of the plurality of models of cars as the second category.

Then, the generation model learning unit 10A inputs text including the second category to the generation model 20 and learns the generation model 20 by a known method by using the plurality of pieces of learning data 22 so that second data 24B belonging to the second category is generated and output by the generation model 20.

The second data 24B is an example of the data 24. The second data 24B is the data 24 belonging to the second category. In a case where the second category is the "model of cars", the generation model learning unit 10A learns the generation model 20 so input of the second category results in output of a plurality of pieces of the second data 24B having higher fidelity with respect to the "model of cars", in which a car of the specific "model of cars" that has been input is captured.

Note that, for the learning of the generation model 20 by the generation model learning unit 10A, it suffices to use fine tuning of updating all the model parameters, a method of updating only some of the model parameters by adding a task-dedicated layer to the model, a method of tuning only a prompt portion of text to be input without updating the model parameters, or the like.

The generator 10B generates the data 24 for each category. The generator 10B inputs a category to the generation model 20 and acquires the data 24 output from the generation model 20, thereby generating the data 24 belonging to the category that has been input. The input of the category may be executed by inputting text including the category to the generation model 20, similarly to the time of learning of the generation model 20 by the generation model learning unit 10A.

Specifically, the generator 10B inputs the first category to the generation model 20 and generates the first data 24A belonging to the first category as output from the generation model 20. In addition, the generator 10B inputs the second category to the generation model 20 and generates the second data 24B belonging to the second category as output from the generation model 20.

Furthermore, when inputting the text including the category to the generation model 20, the generator 10B may set a fidelity parameter (classifier-free guidance scale (CFG scale)) (3. J. Ho, et al., "Classifier-free diffusion guidance." ArXiv preprint arXiv:2207.12598, 2022) to generate the data 24.

The fidelity parameter is a numerical value that specifies how faithful the data 24 is generated for the text including the input category. As the numerical value of the fidelity parameter is larger, the generation model 20 generates the more faithful data 24 for the text including the input category.

Fidelity and diversity of the data 24 are in a trade-off relationship. The higher the fidelity, the more the data 24 having the same composition is generated, and the lower the fidelity, the more diverse the data 24 is generated. That is, as the fidelity parameter of a larger numerical value is set to the generation model 20, a plurality of pieces of the data 24 having the same composition are generated by the generation model 20. Furthermore, as the fidelity parameter of a smaller numerical value is set to the generation model 20, a plurality of pieces of the data 24 having different compositions, namely, being highly diverse, are generated by the generation model 20.

For example, the generator lOB sets a first fidelity parameter to the generation model 20, inputs the first category to the generation model 20, and generates the first data 24A as output from the generation model 20. Furthermore, for example, a second fidelity parameter is set to the generation model 20, the second category is input to the generation model 20, whereby the second data 24B is generated as output from the generation model 20. The first fidelity parameter is an example of the fidelity parameter and is set to the generation model 20 when the first category is input to the generation model 20. The second fidelity parameter is an example of the fidelity parameter and is set to the generation model 20 when the second category is input to the generation model 20.

The first fidelity parameter is an example of the fidelity parameter and is set to the generation model 20 when the first category is input to the generation model 20. The second fidelity parameter is an example of the fidelity parameter and is set to the generation model 20 when the second category is input to the generation model 20.

The generator lOB can set any value as the first fidelity parameter and the second fidelity parameter. It is preferable that the generator lOB sets, to the generation model 20, the second fidelity parameter indicating higher fidelity than the first fidelity parameter.

That is, the generator lOB preferably generates the first data 24A by setting the first fidelity parameter indicating the fidelity lower than the second fidelity parameter to the generation model 20 and inputting the first category to the generation model 20. In this case, the generator lOB can lower the fidelity with respect to the input category (first category) as compared with that for the second data 24B and can cause the generation model 20 to generate various types of the first data 24A having more diversity.

In other words, the generator lOB preferably generates the second data 24B by setting the second fidelity parameter indicating the fidelity higher than the first fidelity parameter to the generation model 20 and inputting the second category to the generation model 20. In this case, the generator lOB can raise the fidelity with respect to the category (second category) that has been input as compared with that for the first data 24A to suppress the data 24, which has higher fidelity and has a high possibility of not belonging to the second category, from being generated as the second data 24B.

Note that the generator lOB may generate the first data 24A belonging to the first category and the second data 24B belonging to the second category by using a machine learning model learned by an information processing device or the like other than the information processing device 10 instead of the generation model 20.

For example, in a case where the learning data 22 is not data of a special domain, the generator 10B may execute generation of the first data 24A and the second data 24B using a generation model pre-learned by the data 24 such as a large amount of general image data.

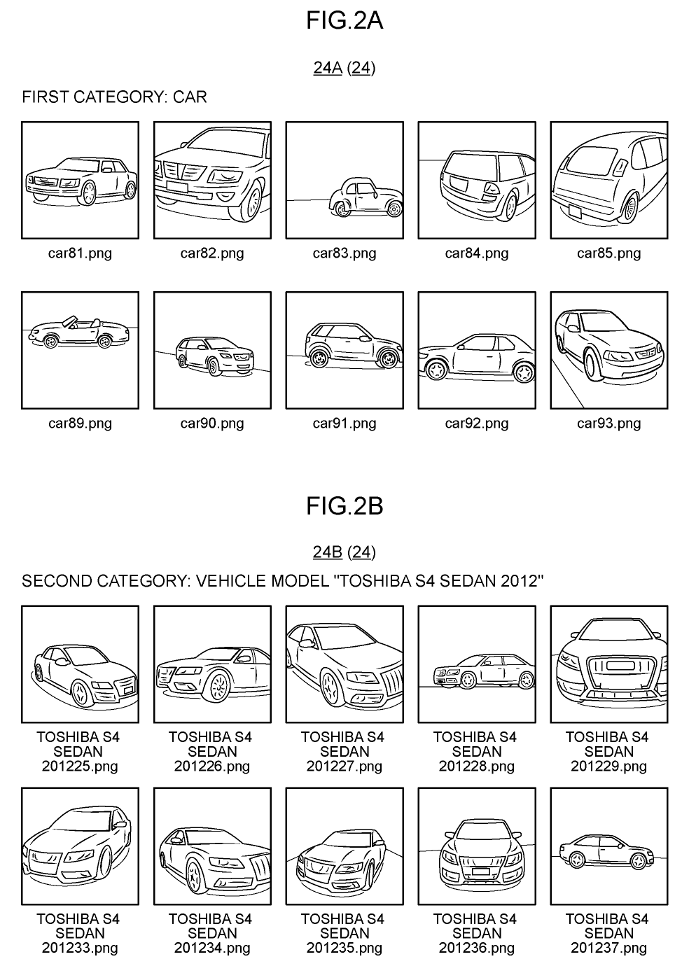

FIGS. 2A and 2B are schematic diagrams of an example of the data 24.

FIG. 2A is a schematic diagram of an example of the first data 24A generated by the generator lOB. FIG. 2A is a schematic diagram of an example of a plurality of pieces of the first data 24A output from the generation model 20 in the case where the generator lOB uses "car" as the first category.

FIG. 2B is a schematic diagram of an example of the second data 24B generated by the generator lOB. FIG. 2B is a schematic diagram illustrating an example of a plurality of pieces of the second data 24B output from the generation model 20 in a case where the generator lOB uses the model of car of "Toshiba S4 Sedan 2012" as the second category.

Returning to FIG. 1, the description will be continued.

The learning unit 10C learns the recognition model 26 by using the data 24 including the first data 24A and the second data 24B.

The recognition model 26 is a machine learning model that receives the data 24 as input and outputs a recognition result of the input data 24. The recognition result is only required to be a recognition result of the data 24.

The recognition result is, for example, a recognition result of an object included in the data 24, a category to which the object included in the data 24 belongs, or the like. In the present embodiment, a mode in which the recognition result output from the recognition model 26 is the category to which the data 24 belongs will be described as an example. The categories may be referred to as classes.

The recognition model 26 is a known neural network. In the present embodiment, a mode in which the recognition model 26 is a machine learning model that executes a classification algorithm such as a classification task will be described as an example. Note that the algorithm executed by the recognition model 26 is not limited to the classification task and may further include one or a plurality of tasks such as object detection and segmentation.

Examples of the recognition model 26 include a model that uses a convolution neural network (CNN) such as VGG (Simonyan, Karen, and Andrew Zisserman. "Very deep convolutional networks for large-scale image recognition." arXiv preprint arXiv: 1409. 1556 (2014)) or ResNet (He, Kaiming, et al. "Deep residual learning for image recognition." Proceedings of the IEEE conference on computer vision and pattern recognition. 2016) as a backbone. Furthermore, the recognition model 26 includes a model that uses a method of directly performing classification of a target object and regression of the region for each pixel of a feature map for estimation of identification of the class of an object region. Examples of this method include a single shot multibox detector (SSD) which is a one-stage detector (Liu Wei, et al. "SSD: Single shot multibox detector." European conference on computer vision. Springer, Cham, 2016) and fully convolutional one-stage object detection (FCOS) (Zhi Tian, et al. "Fcos: Fully convolutional one-stage object detection." Proceedings of the IEEE/CVF international conference on computer vision. 2019).

In addition, as the recognition model 26, a two- stage detector that performs classification and regression of the object region after extracting an object candidate region may be used. Examples of the two-stage detector include Faster R-CNN (Ren, Shaoqing, et al. "Faster r-cnn: Towards real-time object detection with region proposal networks." Advances in neural information processing systems. 2015).

The learning unit 10C learns the recognition model 26 by self-supervised learning using the first data 24A. The learning unit 10C learns the recognition model 26 also by supervised learning using the second data 24B and the second category used for generation of the second data 24B by the generator lOB.

Furthermore, the learning unit 1CC may further learn the recognition model 26 by further using the third data 24C included in the learning data 22 as the data 24 in addition to the first data 24A and the second data 24B. That is, the learning unit 1CC learns the recognition model 26 by using the data 24 including the third data 24C, the first data 24A, and the second data 24B.

Since the learning unit 1CC learns the recognition model 26 by using the data 24 including the third data 24C, the first data 24A, and the second data 24B, even in a case of learning the recognition model 26 for data 24 of a special domain in which it is difficult to prepare a large amount of the data 24 in advance, it is made possible to generate an extended large amount of the data 24 and to use the generated data for learning of the recognition model 26.

The learning unit 10C is only required to learn the recognition model 26 by self-supervised learning using the unsupervised learning data 22B and to learn the recognition model 26 by supervised learning using the supervised learning data 22A.

At the time of learning using the second data 24B and the second category and learning using the supervised learning data 22A, the learning unit 10C is only required to perform supervised learning of the recognition model 26 by using a cross-entropy loss or the like, similarly to known supervised learning. Meanwhile, the learning unit 10C is only required to learn the recognition model 26 by self-supervised learning at the time of learning using the first data 24A and learning using the unsupervised learning data 22B.

Next, an example of a flow of information processing executed by the information processing device 10 of the present embodiment will be described.

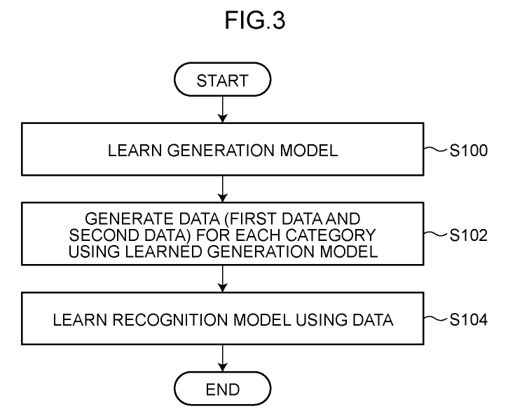

FIG. 3 is a flowchart illustrating an example of the flow of information processing executed by the information processing device 10.

The generation model learning unit 10A learns the generation model 20 by using the learning data 22 (step S100).

The generator lOB generates the data 24 for each category using the generation model 20 learned in step 5100 (step 5102). The generator lOB inputs the first category to the generation model 20 and generates the first data 24A belonging to the first category as output from the generation model 20. In addition, the generator lOB inputs the second category to the generation model 20 and generates the second data 24B belonging to the second category as output from the generation model 20.

Furthermore, as described above, the generator lOB may set the fidelity parameter and generate the data 24 when inputting the text including the category to the generation model 20.

Next, the learning unit 10C learns the recognition model 26 by using the data 24 including the first data 24A and the second data 24B generated in step S102 (step S104).

Then, this routine is ended.

As described above, the information processing device 10 of the present embodiment includes the generator lOB and the learning unit 10C. The learning unit 10C inputs each of the first category, into which the data 24 is classified, and the second category, into which the data 24 is classified more specifically than in the first category, to the generation model (generation model 20) and generates the first data 24A belonging to the first category and the second data 24B belonging to the second category as output from the generation model. The learning unit 1CC learns the recognition model 26 that outputs a recognition result from the data 24 by using the data 24 including the first data 24A and the second data 24B.

Note that, in the related art, since the recognition model is learned using only data that can be used for supervised learning or only data that can be used for unsupervised learning, either one of fidelity or diversity is missing. For this reason, in the related art, there is a case where the recognition accuracy of a recognition model cannot be improved

Meanwhile, in the information processing device 10 of the present embodiment, the recognition model 26 is learned using the first data 24A belonging to the first category and the second data 24B belonging to the second category obtained by classifying the data 24 more specifically than in the first category.

As described above, the first category is a category in which the data 24 is classified into a larger category, namely, a more general category, as compared with the second category. The second category is a category in which the data 24 is classified more specifically than in the first category.

Accordingly, when the plurality of pieces of data 24 are classified, the number of pieces of the data 24 belonging to the first category is greater than or equal to the number of pieces of the data 24 belonging to one or a plurality of second categories. The data 24 belonging to the first category includes pieces of the data 24 belonging to a plurality of different second categories. As such, a plurality of pieces of the various diverse data 24 belong to the first category. On the other hand, since the second category is a category obtained by classifying the data 24 more specifically than in the first category, a plurality of pieces of the data 24 having high fidelity with respect to the second category belong to the second category.

Moreover, in the information processing device 10 of the present embodiment, the recognition model 26 is learned using both the plurality of pieces of first data 24A and the plurality of pieces of second data 24B.

Therefore, the information processing device 10 according to the present embodiment can learn the recognition model 26 that satisfies both fidelity and diversity.

As such, the information processing device 10 according to the present embodiment can improve the recognition accuracy of the recognition model 26.

### Second Embodiment

In the present embodiment, a mode of learning the generation model 20 on the basis of a derived fidelity parameter will be described.

In the present embodiment, the same parts as those in the above embodiment are denoted by the same reference numerals, and a detailed description thereof will be omitted.

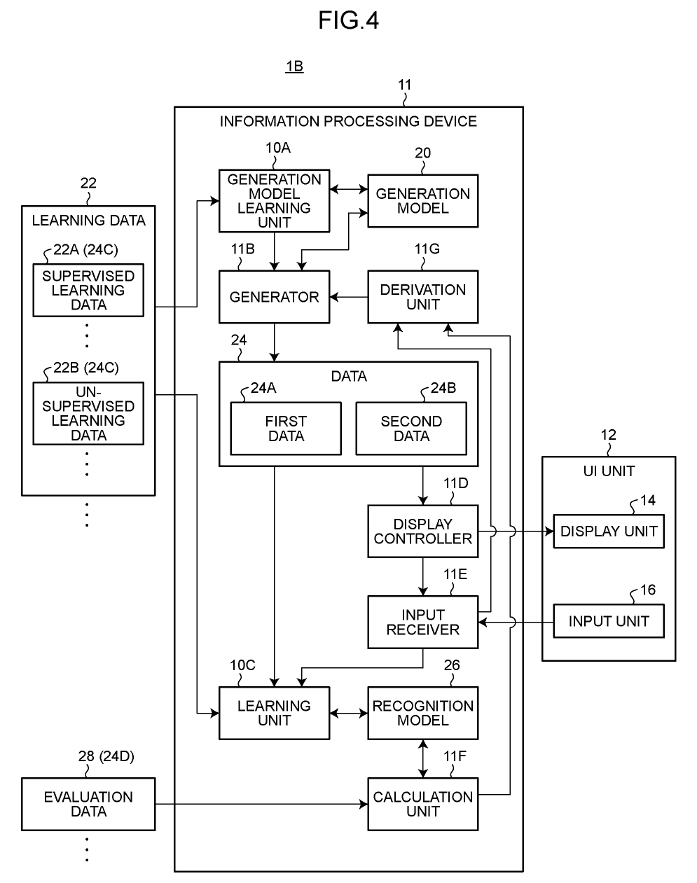

FIG. 4 is a block diagram illustrating an example of the configuration of an information processing system 1B of the present embodiment.

The information processing system 1B includes an information processing device 11 and a user interface (UI) unit 12. The information processing device 11 and the UI unit 12 are communicably connected by wire or wirelessly via a network or the like.

The information processing system 1B is similar to the information processing system 1 of the above embodiment except that the information processing device 11 is included instead of the information processing device 10 and that the UI unit 12 is further included

The UI unit 12 includes a display unit 14 and an input unit 16. The display unit 14 displays various types of information. The display unit 14 is, for example, a display, a projection device, or the like. The input unit 16 receives operation input by a user. The input unit 16 is, for example, a pointing device such as a mouse and a touch pad, a keyboard, or the like. The display unit 14 and the input unit 16 may be integrally configured as a touch panel. Note that the information processing device 11 may include the UI unit 12. Alternatively, the UI unit 12 may be provided in an information processing device that is an external device communicably connected to the information processing device 11 in a wireless or wired manner.

The information processing device 11 includes the generation model learning unit 10A, a generator 11B, a learning unit 10C, a display controller 11D, an input receiver 11E, a calculation unit 11F, and a derivation unit 11G.

The generation model learning unit 10A, the generator 11B, the learning unit 10C, the display controller 11D, the input receiver 11E, the calculation unit 11F, and the derivation unit 11G are implemented by, for example, one or a plurality of processors. For example, each of the above units may be implemented by causing a processor such as a CPU or a GPU to execute a program, namely, by software. Each of the above units may be implemented by a processor such as a dedicated IC, namely, hardware. Each of the above units may be implemented by using software and hardware in combination. In the case of using a plurality of processors, each of the processors may implement one of the units, or may implement two or more of the units.

The generation model 20 and the recognition model 26 may be stored in a storage unit provided in the information processing device 11. Furthermore, at least one of the generation model 20 or the recognition model 26 may be stored in a storage unit provided outside the information processing device 11. Furthermore, the storage unit and at least one of a plurality of functional units included in the information processing device 11 may be mounted on an external information processing device communicably connected to the information processing device 11 via a network or the like.

The generation model learning unit 10A and the learning unit 10C are similar to those in the above embodiment. The information processing device 11 is similar to the information processing device 10 of the above embodiment except that the generator 11B is included instead of the generator 10B and that the display controller 11D, the input receiver 11E, the calculation unit 11F, and the derivation unit 11G are further included.

The generator 11B generates the data 24 for each category, similarly to the generator 10B. That is, the generator 11B inputs a first category to the generation model 20 and generates the first data 24A belonging to the first category as output from the generation model 20. In addition, the generator 11B inputs a second category to the generation model 20 and generates second data 24B belonging to the second category as output from the generation model 20.

In the present embodiment, the generator 11B acquires a fidelity parameter derived for each category by the derivation unit 11G to be described in detail later from the derivation unit 11G.

Then, the generator 11B sets a first fidelity parameter, which is a fidelity parameter derived for the first category by the derivation unit 11G, to the generation model 20, inputs the first category to the generation model 20, and generates the first data 24A as output from the generation model 20. The generator 11B is only required to input text including the first category to the generation model 20, similarly to the generator 10B.

Furthermore, the generator 11B sets a second fidelity parameter, which is a fidelity parameter derived for the second category by the derivation unit 11G, to the generation model 20, inputs the second category to the generation model 20, and generates the second data 24B as output from the generation model 20. The generator 11B is only required to input text including the second category to the generation model 20, similarly to the generator 10B.

The display controller 11D displays the first data 24A and the second data 24B generated by the generator 11B on the display unit 14.

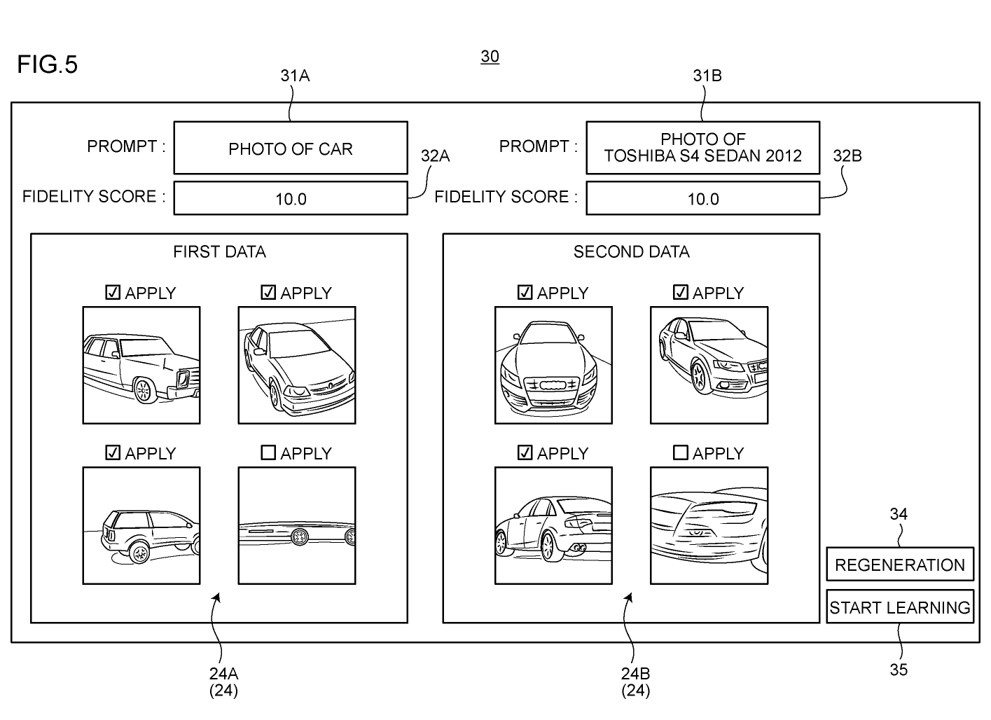

FIG. 5 is a schematic diagram of an example of a display screen 30 displayed on the display unit 14.

On the display screen 30, the data 24 generated by the generator 11B is displayed for each category.

For example, the display controller 11D displays, on the display screen 30, a prompt 31A (a photo of a car, PHOTO OF CAR) that is text including "car" which is an example of the first category and is input to the generation model 20, a fidelity score 32A that is the value of the first fidelity parameter set to the generation model 20 when the first category is input to the generation model 20, and a plurality of pieces of the first data 24A belonging to the first category.

Furthermore, the display controller 11D displays, on the display screen 30, a prompt 31B (a photo of a Toshiba S4 Sedan 2012, PHOTO OF TOSHIBA S4 SEDAN 2012) input to the generation model 20, which is text including the "model of car" of "Toshiba S4 Sedan 2012" that is an example of the second category, a fidelity score 32B that is the value of the second fidelity parameter set to the generation model 20 when the second category is input to the generation model 20, and a plurality of pieces of the second data 24B belonging to the second category.

The user can confirm the list of the generated data 24 by visually recognizing a plurality of pieces of the first data 24A and a plurality of pieces of the second data 24B belonging to the first category and the second category, respectively, displayed on the display screen 30. That is, the display controller 11D can provide a list of the plurality of pieces of data 24 generated for each category by the generator 11B in such a manner that the user can confirm the list.

The display screen 30 includes a regeneration button 34 for receiving a regeneration instruction and a learning start button 35 for receiving a learning start instruction. When the regeneration button 34 on the display screen 30 is selected by an operation instruction of the input unit 16 by the user, the input receiver 11E receives a regeneration instruction. When the learning start button 35 on the display screen 30 is selected by an operation instruction of the input unit 16 by the user, the input receiver 11E receives a learning start instruction

Furthermore, the user may change at least one of the displayed fidelity score 32A that is the value of the first fidelity parameter or the displayed fidelity score 32B that is the value of the second fidelity parameter by operating the input unit 16. For example, in a case where the plurality of pieces of data 24 biased to the same or similar composition are generated as data 24 belonging to each category, the user inputs the value of a fidelity parameter having a lower value. When receiving the input of the fidelity parameter for each category by the operation of the input unit 16 by the user, the input receiver 11E receives the fidelity parameter input for each of the first category and the second category.

Note that the user can select the data 24 to be used for learning. Specifically, the display screen 30 includes a check box for receiving selection of whether or not to use the data 24 in the vicinity of each of the plurality of pieces of displayed data 24. The user can select the data 24 to be used for learning of the recognition model 26 by checking a check box corresponding to a desired piece of the data 24 to be used for learning of the recognition model 26 by operating the input unit 16. The input receiver 11E is only required to receive identification information of data 24 corresponding to a checked check box as identification information of the data 24 used for learning of the recognition model 26 by an operation instruction of the input unit 16 by the user.

Returning to FIG. 4, the description will be continued.

When the input receiver 11E receives the regeneration instruction from the input unit 16, the derivation unit 11G derives a fidelity parameter different from that at the time of creation of the previous data 24 for each of the first category and the second category. Then, the derivation unit 11G outputs the first fidelity parameter that is the fidelity parameter derived for the first category and the second fidelity parameter that is the fidelity parameter derived for the second category to the generator 11B.

Furthermore, a case is presumed where the input receiver 11E receives input of values of the first fidelity parameter for the first category and the second fidelity parameter for the second category from the input unit 16. Presumed is a scene where the input receiver 11E then receives the regeneration instruction from the input unit 16. In this case, the derivation unit 11G derives, as fidelity parameters to be set next time, the first fidelity parameter and the second fidelity parameter having received as the input for each of the first category and the second category. Then, the derivation unit 11G outputs the derived first fidelity parameter and the derived second fidelity parameter to the generator 11B.

Specifically, the user changes at least one of the displayed fidelity score 32A that is the value of the first fidelity parameter or the displayed fidelity score 32B that is the value of the second fidelity parameter by operating the input unit 16. For example, in a case where a plurality of pieces of the data 24 biased to the same or similar composition are generated as the data 24 belonging to each category, the user inputs the value of a fidelity parameter having a lower value. When receiving the input of the fidelity parameter for each of the categories by the user, the input receiver 11E receives the fidelity parameter input for each of the first category and the second category. Then, the derivation unit 11G outputs, to the generator 11B, the first fidelity parameter and the second fidelity parameter having received as the input.

The generator 11B sets the first fidelity parameter, which is the fidelity parameter derived for the first category by the derivation unit 11G, to the generation model 20. Then, the generator 11B inputs the first category to the generation model 20 and generates the first data 24A as the output from the generation model 20. The generator 11B is only required to input the first category to the generation model 20 by inputting text including the first category to the generation model 20, similarly to the generator 10B.

Furthermore, the generator 11B sets the second fidelity parameter, which is the fidelity parameter derived for the second category by the derivation unit 11G, to the generation model 20. Then, the generator 11B inputs the second category to the generation model 20 and generates the second data 24B as the output from the generation model 20. The generator 11B is only required to input the second category to the generation model 20 by inputting text including the second category to the generation model 20, similarly to the generator 10B.

Meanwhile, when the input receiver 11E receives a learning start instruction from the input unit 16, the learning unit 10C learns the recognition model 26 by using the data 24 including the first data 24A and the second data 24B, similarly to the above embodiment.

In addition, a case is presumed where the input receiver 11E has received identification information of the data 24 corresponding to a checked check box as identification information of the data 24 used for learning of the recognition model 26 by an operation instruction of the input unit 16 by the user. In this case, the learning unit 10C is only required to learn the recognition model 26 by using the data 24 identified by the received identification information among the plurality of pieces of data 24 displayed on the display unit 14.

The calculation unit 11F calculates first accuracy and second accuracy by using evaluation data 28.

The evaluation data 28 is used for evaluation of the recognition model 26. The evaluation data 28 includes a pair of reference data 24D and a correct recognition result of the reference data 24D. The reference data 24D is an example of the data 24. The correct recognition result is a recognition result of the correct answer for the reference data 24D. As described in the above embodiment, in the present embodiment, a mode in which the recognition result of the recognition model 26 is a category will be described as an example. Accordingly, description will be given on the premise that the correct recognition result is a correct category to which the reference data 24D belongs.

For each of the plurality of pieces of evaluation data 28, the calculation unit 11F inputs the reference data 24D included in the evaluation data 28 to the recognition model 26 to calculate the first accuracy representing the degree of coincidence between the recognition result output from the recognition model 26 and the correct recognition result corresponding to the reference data 24D.

The calculation unit 11F also calculates the second accuracy to be compared with the first accuracy.

The calculation unit 11F calculates, as the second accuracy, the degree of coincidence between a comparison recognition result, which is output by inputting the reference data 24D to a comparison model learned by only one or a plurality of pieces of the first data 24A, only one or a plurality of pieces of the second data 24B, or only one or a plurality of pieces of the learning data 22, and the correct recognition result corresponding to the reference data 24D. The comparison model is a machine learning model including an algorithm similar to that of the recognition model 26 except that data used for learning is different.

Alternatively, the calculation unit 11F may calculate, as the second accuracy, the degree of coincidence between the comparison recognition result output by inputting the reference data 24D to an in-learning recognition model that is the recognition model 26 in which the progress of learning is at an earlier stage than in the present and the correct recognition result corresponding to the reference data 24D.

The calculation unit 11F calculates a pair of the first accuracy and the second accuracy for each of the plurality of pieces of evaluation data 28. Then, the calculation unit 11F outputs the calculated pair of the first accuracy and the second accuracy and the correct recognition result included in the evaluation data 28 used for the calculation of the first accuracy included in the pair to the derivation unit 11G for each of the correct recognition results.

The derivation unit 11G executes the following processing for each group of the pair of the first accuracy and the second accuracy received from the calculation unit 11F and the correct recognition result included in the evaluation data 28 used for calculation of the first accuracy included in the pair.

Specifically, the derivation unit 11G executes at least one of: deriving a fidelity parameter having a smaller value than that at the time of previous derivation as a fidelity parameter for the category (first category or second category) corresponding to the correct recognition result in which the first accuracy is greater than or equal to the second accuracy; or deriving a number of pieces of generated data larger than that at the time of previous derivation as the number of pieces of the generated data 24 to be generated.

The category corresponding to the correct recognition result means a category (first category or second category) that at least partially matches the correct recognition result, includes the correct recognition result, or is most similar to the correct recognition result.

Furthermore, the derivation unit 11G executes at least one of: deriving a fidelity parameter having a larger value than that at the time of previous derivation as a fidelity parameter for the category (first category or second category) corresponding to the correct recognition result in which the first accuracy is less than the second accuracy; or deriving a number of pieces of generated data smaller than that at the time of previous derivation

In other words, the derivation unit 11G executes adjustment processing such as lowering the value of the fidelity parameter and increasing the number of pieces of the generated data 24 such that the plurality of pieces of data 24 with more diversity are generated for the category of which the first accuracy is greater than or equal to the second accuracy.

Furthermore, for a category of which the first accuracy is less than the second accuracy, the derivation unit 11G executes adjustment processing such as increasing the value of the fidelity parameter and decreasing the number of pieces of the generated data 24 such that the plurality of pieces of data 24 with higher fidelity is generated for the category.

As such, in the present embodiment, the derivation unit 11G can derive at least one of the fidelity parameter or the number of pieces of generated data that can improve the recognition accuracy of the recognition model 26 for each category

Note that a search based on grid search or Bayesian optimization of a general hyperparameter search method may be used for the search of the fidelity parameter for the derivation of the fidelity parameter by the derivation unit 11G.

The generator 11B sets the first fidelity parameter, which is the fidelity parameter derived for the first category by the derivation unit 11G, to the generation model 20 and inputs the first category to the generation model 20. The generator 11B is only required to input the first category to the generation model 20 by inputting text including the first category to the generation model 20, similarly to the generator 10B. In a case where the derivation unit 11G has derived the number of pieces of the generated data 24 for the first category, the generator 11B sets the number of pieces of generated first data 24A to the generation model 20. Then, the generator 11B generates a number of pieces of first data 24A, the number of pieces of the generated first data 24A derived for the first category by the derivation unit 11G, as the output from the generation model 20.

Furthermore, the generator 11B sets the second fidelity parameter, which is the fidelity parameter derived for the second category by the derivation unit 11G, to the generation model 20 and inputs the second category to the generation model 20. The generator 11B is only required to input the second category to the generation model 20 by inputting text including the second category to the generation model 20, similarly to the generator 10B. In a case where the derivation unit 11G has derived the number of pieces of the generated data 24 for the second category, the generator 11B sets the number of pieces of generated second data 24B to the generation model 20. Then, the generator 11B generates the number of pieces of the second data 24B, the number of pieces of the generated second data 24B derived for the second category by the derivation unit 11G, as the output from the generation model 20.

Accordingly, in the information processing device 11 of the present embodiment, the first data 24A of the first category and the second data 24B of the second category can be generated using the generation model 20 in which the fidelity parameter corresponding to the accuracy of the recognition model 26 or a confirmation result of the data 24 generated by the user is set. Furthermore, the information processing device 11 can generate the data 24 used for learning of the recognition model 26, which can further improve the recognition accuracy of the recognition model 26.

Next, an example of a flow of information processing executed by the information processing device 11 of the present embodiment will be described.

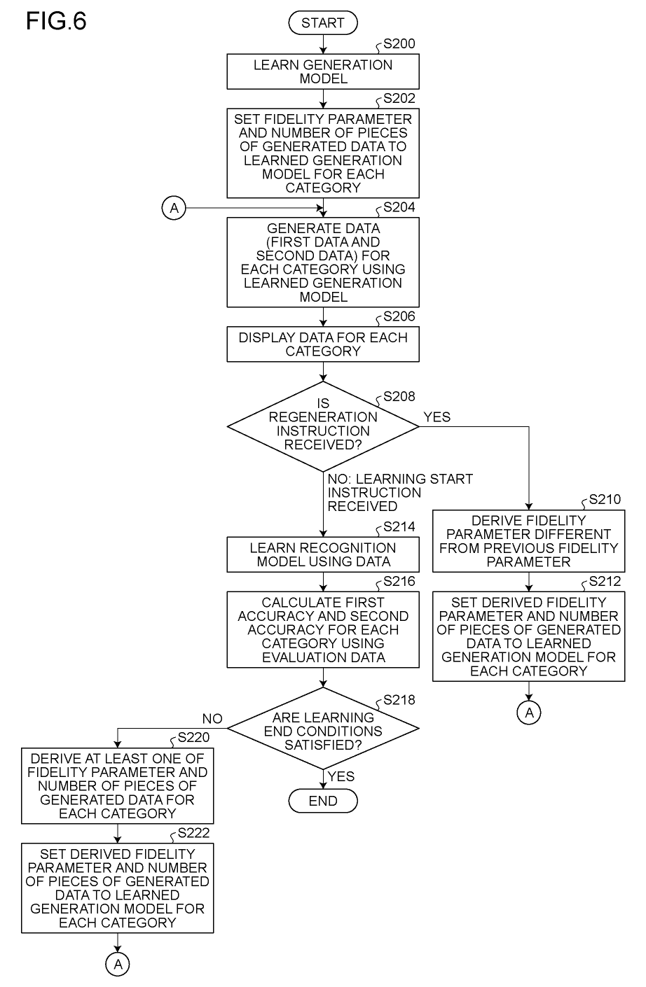

FIG. 6 is a flowchart illustrating an example of the flow of information processing executed by the information processing device 11.

The generation model learning unit 10A learns the generation model 20 by using the learning data 22 (step S200).

The generator 11B sets the fidelity parameter and the number of pieces of the generated data 24 to the generation model 20 learned in step S200 for each category (step S202). For example, in step S202, the generator 11B sets the fidelity parameter and the number of pieces of generated data preset for each category as initial values.

Every time the fidelity parameter and the number of pieces of generated data are set for each category, the generator 11B inputs the text including the category to the generation model 20 learned in step S200. Then, the generator 11B generates the data 24 for each category by acquiring the data 24 output from the generation model 20 (by using the learned generation model) (step S204).

Specifically, the generator 11B inputs the first category to the generation model 20 in which the first fidelity parameter and the number of pieces of generated data for the first category are set, and generates this number of pieces of the first data 24A belonging to the first category as the output from the generation model 20. Furthermore, the generator 11B inputs the second category to the generation model 20 in which the second fidelity parameter and the number of pieces of generated data for the second category are set, and generates this number of pieces of the second data 24B belonging to the second category as the output from the generation model 20.

The display controller 11D displays the first data 24A and the second data 24B generated in step S204 on the display unit 14 for each category (step S206). By the processing of step S206, for example, the display screen 30 illustrated in FIG. 5 is displayed on the display unit 14.

Next, the input receiver 11E determines whether or not a regeneration instruction has been received (step S208). If the input receiver 11E determines that the regeneration instruction has been received (step S208: Yes), the derivation unit 11G derives a fidelity parameter different from that at the time of creation of the previous data 24 for each of the first category and the second category (step S210). Furthermore, in a case where the input receiver 11E receives input of the values of the first fidelity parameter for the first category and the second fidelity parameter for the second category from the input unit 16, the derivation unit 11G derives the first fidelity parameter and the second fidelity parameter that have been received for the first category and the second category, respectively.

The generator 11B sets the fidelity parameter that has been derived in step S210 and the number of pieces of the generated data 24 to the generation model 20 learned in step S200 for each of the categories (step S212). Then, the process proceeds to step S204.

If it is determined in step S208 that the input receiver 11E has received the learning start instruction (step S208: No), the process proceeds to step S214.

In step S214, the learning unit 10C learns the recognition model 26 by using the data 24 including the first data 24A and the second data 24B generated in step S204 (step S214).

The calculation unit 11F calculates the first accuracy and the second accuracy of the evaluation data 28 for each of the categories by using the evaluation data 28 (step S216). For each of the plurality of pieces of evaluation data 28, the calculation unit 11F inputs the reference data 24D included in the evaluation data 28 to the recognition model 26 to calculate the first accuracy representing the degree of coincidence between the recognition result output from the recognition model 26 and the correct recognition result corresponding to the reference data 24D. The calculation unit 11F also calculates the second accuracy to be compared with the first accuracy for each category.

Next, the information processing device 11 determines whether or not learning end conditions of the recognition model 26 are satisfied (step S218). For example, the information processing device 11 determines whether or not the number of times of learning in step S214 is greater than or equal to a predetermined threshold value, thereby making the determination in step S218. If an affirmative determination is made in step S218 (step S218: Yes), this routine is ended. If a negative determination is made in step S218 (step S218: No), the process proceeds to step S220.

In step S220, the derivation unit 11G derives at least one of the fidelity parameter and the number of pieces of the generated data 24 for each of the categories on the basis of the pair of the first accuracy and the second accuracy calculated for each category in step S214 (step S220).

The derivation unit 11G receives a plurality of groups of pairs of the first accuracy and the second accuracy from the calculation unit 11F and correct recognition results included in the evaluation data 28 used for calculation of the first accuracy included in the pairs. Then, the derivation unit 11G executes the following processing for each group.

Specifically, the derivation unit 11G executes at least one of: deriving a fidelity parameter having a smaller value than that at the time of previous derivation as a fidelity parameter for the category (first category or second category) corresponding to the correct recognition result in which the first accuracy is greater than or equal to the second accuracy; or deriving a number of pieces of generated data larger than that at the time of previous derivation as the number of pieces of the generated data 24 to be generated.

Furthermore, the derivation unit 11G executes at least one of: deriving a fidelity parameter having a larger value than that at the time of previous derivation as a fidelity parameter for the category (first category or second category) corresponding to the correct recognition result in which the first accuracy is less than the second accuracy; or deriving a number of pieces of generated data smaller than that at the time of previous derivation.

The generator 11B sets the fidelity parameter that has been derived in step S220 and the number of pieces of the generated data 24 to the generation model 20 learned in step S200 for each of the categories (step S222). Then, the process proceeds to step S204.

As described above, in the information processing device 11 according to the present embodiment, the derivation unit 11G derives the fidelity parameter for each category including the first category and the second category. Then, the generator 11B sets the first fidelity parameter, which is the fidelity parameter derived for the first category by the derivation unit 11G, to the generation model 20 and inputs the first category to the generation model 20. Then, the generator 11B generates the first data 24A as the output from the generation model 20. Furthermore, the generator 11B sets the second fidelity parameter, which is the fidelity parameter derived for the second category by the derivation unit 11G, to the generation model 20 and inputs the second category to the generation model 20. Then, the generator 11B generates the second data 24B as the output from the generation model 20.

Therefore, in the information processing device 11 of the present embodiment, the derivation unit 11G derives at least one of the fidelity parameter corresponding to the accuracy of the recognition model 26 or the confirmation result of the data 24 generated by the user or the number of pieces of the generated data 24, which makes it possible to generate the data 24 used for learning of the recognition model 26 which can further improve the recognition accuracy of the recognition model 26.

Therefore, the information processing device 11 of the present embodiment can further improve the recognition accuracy of the recognition model in addition to the effects of the above embodiment

Next, an exemplary hardware configuration of the information processing device 10 and the information processing device 11 according to the above-described embodiments will be described.

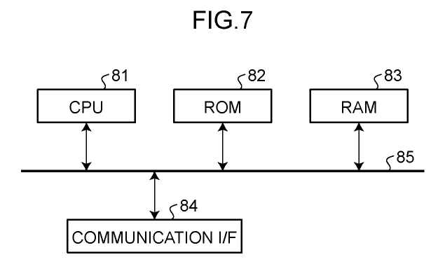

FIG. 7 is a hardware configuration diagram of an example of the information processing device 10 and the information processing device 11 according to the embodiments.

The information processing device 10 and the information processing device 11 of the above embodiments have a hardware configuration using a normal computer, in which a central processing unit (CPU) 81, a read only memory (ROM) 82, a random access memory (RAM) 83, a communication I/F 84, and the like are connected to each other via a bus 85.

The CPU 81 is an arithmetic device that controls the information processing device 10 and the information processing device 11 of the above embodiments. The ROM 82 stores programs and the like for implementing various types of processing by the CPU 81. Although the CPU is used in the description here, a graphics processing unit (GPU) may be used as an arithmetic device that controls the information processing device 10 and the information processing device 11. The RAM 83 stores data necessary for various types of processing by the CPU 81. The communication I/F 84 is an interface for connecting to a display unit 14 and the like to transmit and receive data.

In the information processing device 10 and the information processing device 11 according to the above-described embodiments, the CPU 81 reads a program from the ROM 82 onto the RAM 83 and executes the program, whereby the above-described functions are implemented on the computer.

Note that the program for executing each of the above types of processing executed by the information processing device 10 and the information processing device 11 of the embodiments may be stored in a hard disk drive (HDD). Furthermore, the program for executing each of the above types of processing executed by the information processing device 10 and the information processing device 11 of the embodiments may be provided by being incorporated in the ROM 82 in advance.

Furthermore, the program for executing the above-described processing executed by the information processing device 10 and the information processing device 11 of the above embodiments may be stored as a file in an installable format or an executable format in a computer-readable storage medium such as a CD-ROM, a CD-R, a memory card, a digital versatile disk (DVD), or a flexible disk (FD) and provided as a computer program product. In addition, the program for executing the processing executed by the information processing device 10 and the information processing device 11 according to the above embodiments may be stored on a computer connected to a network such as the Internet and provided by being downloaded via the network. Furthermore, the program for executing the above-described processing executed by the information processing device 10 and the information processing device 11 according to the embodiments may be provided or distributed via a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
one or more hardware processors configured to function as:
a generator that inputs each of a first category into which data is classified and a second category into which the data is classified more specifically than in the first category to a generation model and generates first data belonging to the first category and second data belonging to the second category as output from the generation model; and
a learning unit that learns a recognition model that outputs a recognition result from the data by using the data including the first data and the second data.

2. The information processing device according to claim 1, wherein
the learning unit
learns the recognition model by self-supervised learning using the first data, and
learns the recognition model by supervised learning using the second data and the second category used for generation of the second data by the generator.

3. The information processing device according to claim 1, wherein the one or more hardware processors are configured to further function as:
a generation model learning unit that learns the generation model by using learning data including third data.

4. The information processing device according to claim 3, wherein
the learning unit learns the recognition model by using the data including the third data, the first data, and the second data.

5. The information processing device according to claim 3, wherein
the generation model learning unit learns the generation model by setting a category to which all of a plurality of pieces of the third data included in a plurality of pieces of the learning data belong as the first category.

6. The information processing device according to claim 3, wherein
the learning data includes supervised learning data including third data and a third category to which the third data belongs and unsupervised learning data including the third data, and
the generation model learning unit learns the generation model by supervised learning using the third category included in the supervised learning data as the second category.

7. The information processing device according to claim 1,
wherein the generator sets a first fidelity parameter to the generation model, inputs the first category to the generation model, and generates the first data as output from the generation model, and
the generator sets a second fidelity parameter to the generation model, inputs the second category to the generation model, and generates the second data as output from the generation model.

8. The information processing device according to claim 7, wherein
the generator sets, to the generation model, the second fidelity parameter representing higher fidelity than the first fidelity parameter.

9. The information processing device according to claim 7, wherein the one or more hardware processors are configured to further function as:
a derivation unit that derives a fidelity parameter for each of categories including the first category and the second category, wherein
the generator
sets the first fidelity parameter to the generation model, the first fidelity parameter being the fidelity parameter derived by the derivation unit for the first category, inputs the first category to the generation model, and generates the first data as output from the generation model, and
sets the second fidelity parameter to the generation model, the second fidelity parameter being the fidelity parameter derived by the derivation unit for the second category, inputs the second category to the generation model, and generates the second data as output from the generation model.

10. The information processing device according to claim 9, wherein the one or more hardware processors are configured to further function as:
a calculation unit that calculates first accuracy and second accuracy to be compared with the first accuracy, the first accuracy representing a degree of coincidence between a recognition result and a correct recognition result, the recognition result output from the recognition model by inputting reference generation data to the recognition model, the reference generation data included in evaluation data including a pair of the reference generation data and the correct recognition result of the reference generation data, wherein
the derivation unit
executes at least one of: deriving the fidelity parameter having a smaller value than a value at a previous derivation as the fidelity parameter for a category corresponding to the correct recognition result having the first accuracy greater than or equal to the second accuracy; or deriving a number of pieces of generated data larger than a number of pieces of generated data at a previous calculation as the number of pieces of generated data of pieces of the data to be generated, and
executes at least one of: deriving the fidelity parameter having a larger value than a value at a previous derivation as the fidelity parameter for a category corresponding to the correct recognition result having the first accuracy less than the second accuracy; or deriving a number of pieces of generated data less than a number of pieces of generated data at a previous derivation, and
the generator
sets the first fidelity parameter to the generation model, the first fidelity parameter being the fidelity parameter derived by the derivation unit for the first category, inputs the first category to the generation model, and generates a number of pieces of the first data derived by the derivation unit for the first category as output from the generation model, and
sets the second fidelity parameter to the generation model, the second fidelity parameter being the fidelity parameter derived by the derivation unit for the second category, inputs the second category to the generation model, and generates a number of pieces of the second data derived by the derivation unit for the second category as output from the generation model.

11. The information processing device according to claim 10, wherein
the calculation unit calculates the second accuracy representing:
a degree of coincidence between a comparison recognition result and the correct recognition result, the comparison recognition result output by inputting the reference generation data to a comparison model learned by only the first data, only the second data, or only learning data; or
a degree of coincidence between a comparison recognition result and the correct recognition result, the comparison recognition result output by inputting the reference generation data to an in-learning recognition model that is the recognition model of which progress of learning is at an earlier stage than a present.

12. The information processing device according to claim 1, wherein the one or more hardware processors are configured to further function as:
a display controller that displays the first data and the second data on a display device.

13. An information processing system comprising:
a generator that inputs each of a first category into which data is classified and a second category into which the data is classified more specifically than in the first category to a generation model and generates first data belonging to the first category and second data belonging to the second category as output from the generation model; and
a learning unit that learns a recognition model that outputs a recognition result from the data by using the data including the first data and the second data.

14. An information processing method executed by a computer of an information processing device, the method comprising:
inputting each of a first category into which data is classified and a second category into which the data is classified more specifically than in the first category to a generation model and generating first data belonging to the first category and second data belonging to the second category as output from the generation model; and
learning a recognition model that outputs a recognition result from the data by using the data including the first data and the second data.
